(19) United States
(12) Patent Application Publication
(10) Pub. No.: US 2017/0153016 A1
(43) Pub. Date: Jun. 1, 2017

(54) OMNIDIRECTIONAL LED LAMP

(71) Applicant: ALDER OPTOMECHANICAL CORP., Taoyuan (TW)

(72) Inventors: CHIEN-KUO LEE, Taoyuan (TW); CHING-TAI LU, Taoyuan (TW); YI-CHENG SU, Taoyuan (TW)

(21) Appl. No.: 15/361,107

(22) Filed: Nov. 25, 2016

(30) Foreign Application Priority Data
Nov. 30, 2015 (TW) 104219212

(51) Int. Cl. F21V 29/77; F21V 19/00; F21V 21/28; F21V 23/02; F21V 3/00; F21V 19/02

(52) U.S. Cl. CPC F21V 29/77; F21V 3/00; F21V 19/02; F21V 21/28; F21V 23/02; F21V 19/003; F21Y 2115/10

(57) ABSTRACT

An omnidirectional LED lamp includes a heat sink installed at the top of a lampholder, a first photoelectric unit installed at the bottom of the lampholder, a second photoelectric unit installed at the top of the lampholder, and a power supply module mounted on the lampholder and electrically coupled to the first photoelectric unit and the second photoelectric unit, and the power supply module converts an external power into a rated direct current for turning on the first and second photoelectric units. With the light irradiation of the first and second photoelectric units, an omnidirectional lighting effect that projects light upwardly and downwardly from the lampholder is achieved.

### FIELD OF INVENTION

The present invention relates to a lamp, in particular to an omnidirectional LED lamp capable of providing light that disperses in all directions.

### BACKGROUND OF INVENTION

1. Description of the Related Art

In recent years, high power solid lighting technology advances constantly, and the technologies of packing process and phosphor material continue to develop and become mature, so that the light emission efficiency of the light emitting diode (LED) is improved rapidly. Since the LED has the advantages of saving power, carbon reduction, low cost, high light emission efficiency, small volume, long service life and pure spectrum, therefore various different applications of LED on lighting products are introduced, and the LED is not just used extensively in the area of indoor lighting only, but also used to replace the conventional incandescent and fluorescent lamps progressively.

LED is a light source with strong directivity and the properties of a point light source, therefore the conventional LED lamp generally comes with different quantities of LED elements installed on a substrate, and the LED elements are arranged densely on a surface of the substrate in a matrix form to provide a sufficient light intensity.

As high power technologies advance, LED is facing an increasingly harsher challenge for thermal management, and the LED not just has the property of changing with contact surface only (such as attenuating the light intensity or resulting in a color shift or flicker, etc), but also accelerates the deterioration of the main body and packaging materials. The primary causes reside on the adjustment of the driving current and the internal contact temperature of the LED.

Therefore, the application of LED element as a light source of a lamp (known as LED lamp) needs improvements of the cooling technology related to the LED element to meet the cooling requirement of the high power LED, and the LED lamp also requires related cooling mechanisms to enhance the overall waste heat discharging effect of the LED lamp.

Most conventional LED lamps comprise an aluminum substrate installed at the top of a lampholder, a plurality of LED elements installed on the aluminum substrate, and a lamp cover combined with the lampholder for protecting the LED elements. During the operation of the LED lamp, the aluminum substrate and the lampholder (both made of aluminum) acts as a cooling mechanism. However, the light source produced by the LED elements in such structural design can just be emitted from the lamp cover on any one of both sides of the aluminum substrate, and the omnidirectional lighting effect cannot be achieved.

2. Summary of the Invention

Therefore, it is a primary objective of the present invention to overcome the drawbacks of the prior art by providing an omnidirectional LED lamp with an omnidirectional lighting effect.

To achieve the aforementioned and other objectives, the present invention provides an omnidirectional LED lamp comprising: a lampholder, a first photoelectric unit, a second photoelectric unit, and a power supply module; characterized in that the lampholder comprises a heat sink installed at the top of the lampholder; the first photoelectric unit has at least one first LED element installed to the bottom of the lampholder for projecting a light source downwardly from the lampholder; the second photoelectric unit has at least one second LED element installed to a position at the periphery of the top of the lampholder for projecting a light source upwardly from the lamp; and the power supply module is mounted onto the lampholder and provided for converting an external power into a rated direct current and electrically coupled to the first photoelectric unit and the second photoelectric unit.

According to the characteristics of the aforementioned structure, the lampholder is installed at an appropriate using position, and a power supply module is connected to an external power supply for the use of the omnidirectional LED lamp of the present invention. In a normal application, the power supply module converts the external power into a rated direct current to turn on the first and second photoelectric units. Under the illumination provided by the light source of first and second photoelectric units, the omnidirectional lighting effect allows the omnidirectional LED lamp to project light downwardly and upwardly from the lampholder.

According to the characteristics of the aforementioned structure, the omnidirectional LED lamp has a support frame mounted onto the lampholder, and the support frame has at least one mounting hole.

According to the characteristics of the aforementioned structure, the omnidirectional LED lamp has a support frame axially mounted onto the lampholder and capable of rotating with respect to the lampholder, and the support frame has at least one mounting hole.

According to the characteristics of the aforementioned structure, the first photoelectric unit has at least one first translucent cover for covering the at least one first LED element.

According to the characteristics of the aforementioned structure, the second photoelectric unit has at least one second translucent cover for covering the at least one second LED element.

According to the characteristics of the aforementioned structure, the omnidirectional LED lamp has a support frame axially mounted onto the lampholder and capable of rotating with respect to the lampholder, and the support frame has at least one mounting hole; the first photoelectric unit has at least one first translucent cover for covering the at least one first LED element; and the second photoelectric unit has at least one second translucent cover for covering the at least one second LED element.

According to the characteristics of the aforementioned structure, the first photoelectric unit has a plurality of first LED elements installed to the bottom of the lampholder, and each of the first LED elements has a plurality of LEDs packaged onto a sector substrate.

According to the characteristics of the aforementioned structure, the second photoelectric unit has a plurality of second LED elements surrounded around the periphery of the top of the lampholder, and each of the second LED elements has a plurality of LEDs packaged onto an arc substrate.

According to the characteristics of the aforementioned structure, the power supply module is mounted onto the heat sink of the lampholder.

According to the characteristics of the aforementioned structure, the heat sink is installed at the center of the top of the lampholder, and the heat sink has a plurality of radially configured fins.

Specifically, the omnidirectional LED lamp of the present invention is capable of projecting the light source in a range below the lampholder under the lighting of the light source of the first photoelectric unit, and projecting the light source in a range above the lampholder under the lighting of the light source of the second photoelectric unit. The invention overcomes the shortcoming of the conventional LED lamp that cannot produce the omnidirectional lighting effect and uses a positive and reliable measure to improve the applicability and practicability of the LED lamp.

### BRIEF DESCRIPTION OF THE DRAWINGS

FIG. 1 is a perspective view of an omnidirectional LED lamp of the present invention viewing from the bottom of a lampholder;

FIG. 2 is a perspective view of an omnidirectional LED lamp of the present invention viewing from the top of a lampholder;

FIG. 3 is a schematic view of a first photoelectric unit of the present invention; and

FIG. 4 is a schematic view of a second photoelectric unit of the present invention.

### DESCRIPTION OF THE PREFERRED EMBODIMENTS

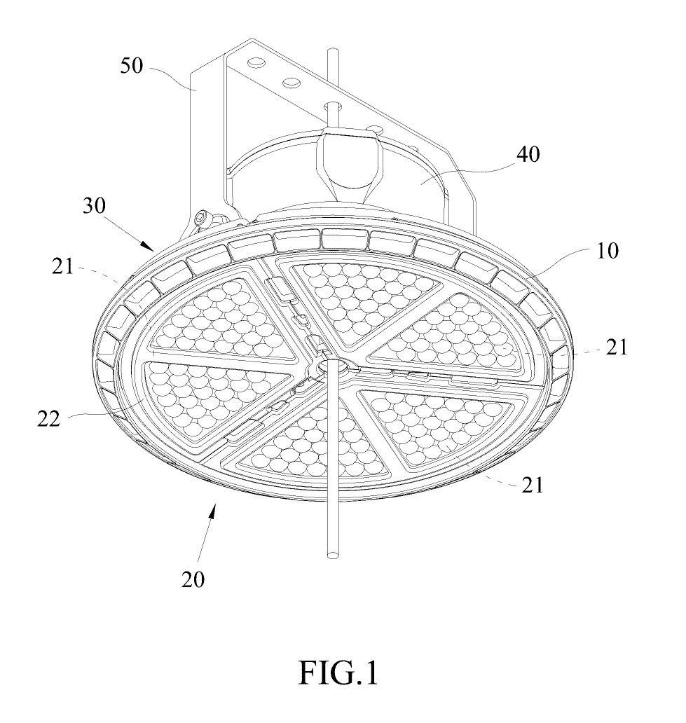

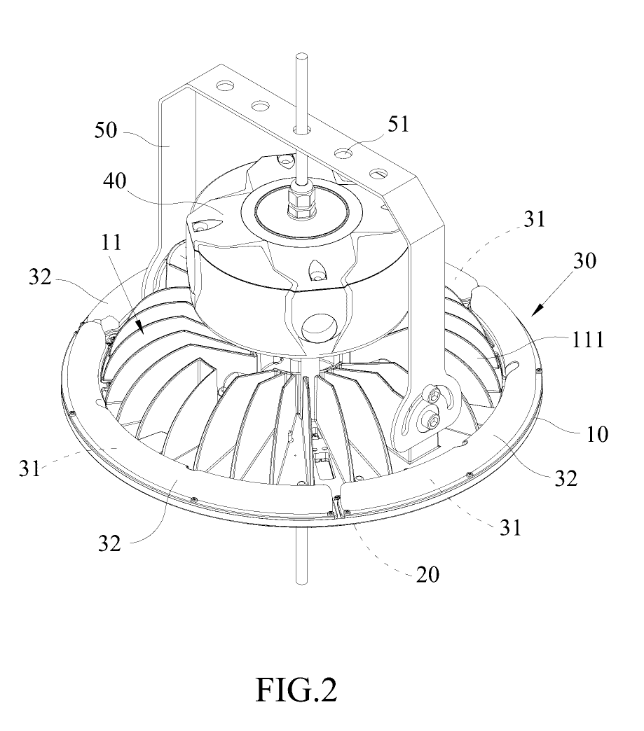

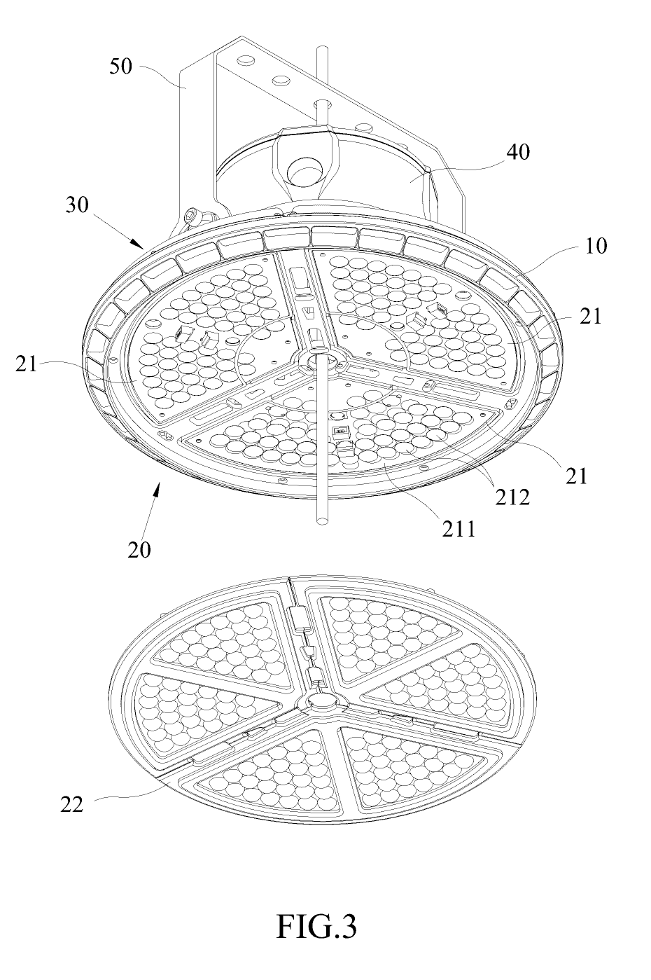

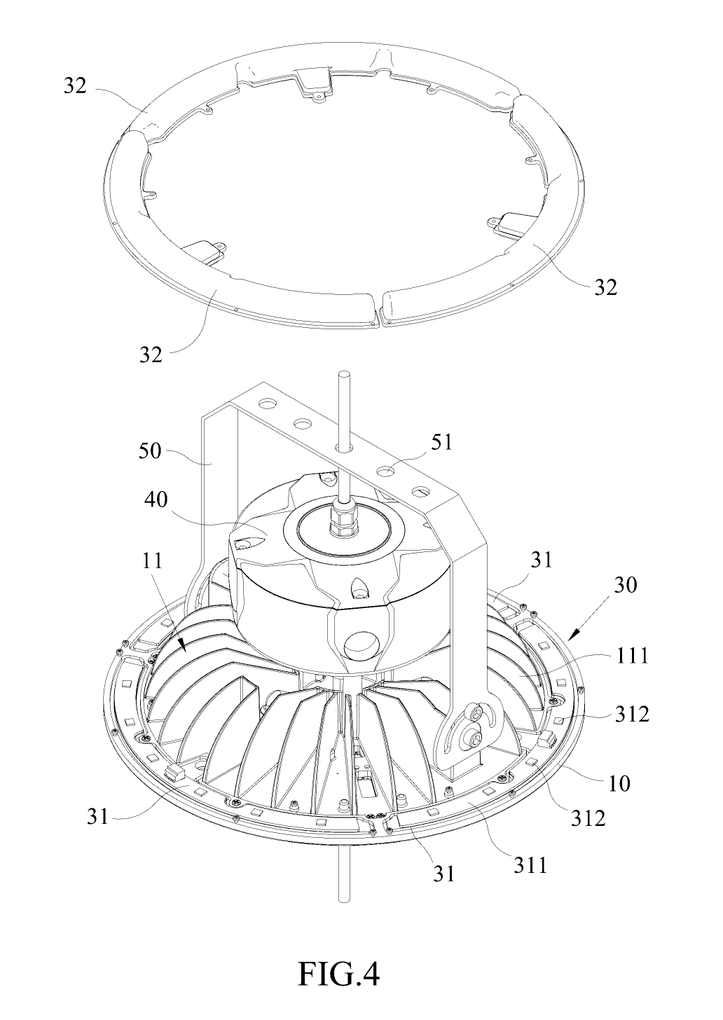

With reference to FIGS. 1 to 4 for an omnidirectional LED lamp with an omnidirectional lighting effect in accordance with the present invention, the omnidirectional LED lamp comprises a lampholder 10, a first photoelectric unit 20, a second photoelectric unit 30, and a power supply module 40.

The lampholder 10 has a heat sink 11 installed at the top of the lampholder 10. In an embodiment, the heat sink 11 has a plurality of fins 111 provided for increasing the air contact area of the heat sink 11 to improve the overall waste heat discharge effect of the omnidirectional LED lamp. In this embodiment, the heat sink 11 is installed at the center of the top of the lampholder 10 and has a plurality of radially configured fins 111.

The first photoelectric unit 20 has at least one first LED element 21 installed at the bottom of the lampholder 10 and used as a light source for projecting light downwardly from the lampholder 10, and primarily used to project a light source into a range below the lampholder 10.

The second photoelectric unit 30 has at least one second LED element 31 installed at the top of the lampholder 10 and used as a light source for projecting light upwardly from the lampholder 10, and primarily used to project a light source into a range above lampholder 10.

The power supply module 40 is mounted onto the lampholder 10 for converting an external power into a rated direct current and electrically coupled to the first photoelectric unit 20 and the second photoelectric unit 30. In an embodiment, the power supply module 40 may be mounted onto the heat sink 11 of the lampholder 10 to achieve a better cooling effect.

In principle of the application of the omnidirectional LED lamp of the present invention, the lampholder 10 is installed at an appropriate using position, and the power supply module 40 is connected to an external power supply. Under a normal using status, the power supply module 40 converts the external power into a rated direct current for turning on the first and second photoelectric units 20, 30; and under the lighting of the light source of the first photoelectric unit 20, the light source is projected in a range below the lampholder 10. Under the lighting of the light source of the second photoelectric unit 30, the light source is projected into a range above the lampholder 10, so that the omnidirectional lighting effect with the effect of projecting the light upwardly and downwardly from the lampholder 10.

In an embodiment of the omnidirectional LED lamp of the present invention, the lampholder has a support frame, and at least one mounting hole formed on the support frame provided for installing the omnidirectional LED lamp conveniently. In this embodiment, the omnidirectional LED lamp has a support frame 50 axially mounted onto the lampholder 10 and capable of rotating with respect to the lampholder 10. The support frame 50 has at least one mounting hole 51, so that the omnidirectional LED lamp has the function of adjusting the angle of the light source.

In addition, the first photoelectric unit 20 has at least one first translucent cover 22 for covering the at least one first LED element 21; similarly, the second photoelectric unit 30 also has at least one second translucent cover 32 for covering the at least one second LED element 31. In an embodiment, the first translucent cover 22 and the second translucent cover 32 are made of polycarbonate (PC), glass or acrylic.

As shown in the figures, the omnidirectional LED lamp preferably has a support frame 50 axially installed on the lampholder 10 and capable of rotating with respect to the lampholder 10 and having at least one mounting hole 51; the first photoelectric unit 20 has at least one first translucent cover 22 for covering the at least one first LED element 21; and the second photoelectric unit 30 has at least one second translucent cover 32 for covering the at least one second LED element 31.

In the aforementioned embodiments of the omnidirectional LED lamp of the present invention, the first photoelectric unit 20 may have a plurality of first LED elements 21 installed at the bottom of the lampholder 10, and each of the first LED elements 21 has a plurality of LEDs 212 packaged to a sector substrate 211, and the second photoelectric unit 30 may have a plurality of second LED elements 31 surrounding the periphery of the top of the lampholder 10, and each of the second LED elements 31 has a plurality of LEDs 312 packaged to an arc substrate 311.

Compared with the prior art, the omnidirectional LED lamp of the present invention is capable of projecting the light source in a range below the lampholder under the lighting of the light source of the first photoelectric unit, and projecting the light source in a range above the lampholder under the lighting of the light source of the second photoelectric unit. The invention overcomes the shortcoming of the conventional LED lamp that cannot produce the omnidirectional lighting effect and uses a positive and reliable measure to improve the applicability and practicability of the LED lamp.

While the invention has been described by means of specific embodiments, numerous modifications and variations could be made thereto by those skilled in the art without departing from the scope and spirit of the invention set forth in the claims.

What is claimed is:

1. An omnidirectional LED lamp, comprising: a lampholder, a first photoelectric unit, a second photoelectric unit, and a power supply module; characterized in that the lampholder comprises a heat sink installed at the top of the lampholder; the first photoelectric unit has at least one first LED element installed to the bottom of the lampholder for projecting a light source downwardly from the lampholder; the second photoelectric unit has at least one second LED element installed to a position at the periphery of the top of the lampholder for projecting a light source upwardly from the lamp; and the power supply module is mounted onto the lampholder and provided for converting an external power into a rated direct current and electrically coupled to the first photoelectric unit and the second photoelectric unit.

2. The omnidirectional LED lamp of claim 1, wherein the omnidirectional LED lamp has a support frame mounted onto the lampholder, and the support frame has at least one mounting hole.

3. The omnidirectional LED lamp of claim 1, wherein the omnidirectional LED lamp has a support frame axially mounted onto the lampholder and capable of rotating with respect to the lampholder, and the support frame has at least one mounting hole.

4. The omnidirectional LED lamp of claim 1, wherein the first photoelectric unit has at least one first translucent cover for covering the at least one first LED element.

5. The omnidirectional LED lamp of claim 1, wherein the second photoelectric unit has at least one second translucent cover for covering the at least one second LED element.

6. The omnidirectional LED lamp of claim 1, wherein the omnidirectional LED lamp has a support frame axially mounted onto the lampholder and capable of rotating with respect to the lampholder, and the support frame has at least one mounting hole; the first photoelectric unit has at least one first translucent cover for covering the at least one first LED element; and the second photoelectric unit has at least one second translucent cover for covering the at least one second LED element.

7. The omnidirectional LED lamp of claim 1, wherein the first photoelectric unit has a plurality of first LED elements installed to the bottom of the lampholder, and each of the first LED elements has a plurality of LEDs packaged onto a sector substrate.

8. The omnidirectional LED lamp of claim 1, wherein the second photoelectric unit has a plurality of second LED elements surrounded around the periphery of the top of the lampholder, and each of the second LED elements has a plurality of LEDs packaged onto an arc substrate.

9. The omnidirectional LED lamp of claim 1, wherein the power supply module is mounted onto the heat sink of the lampholder.

10. The omnidirectional LED lamp of claim 1, wherein the heat sink is installed at the center of the top of the lampholder, and the heat sink has a plurality of radially configured fins.
